(19) United States
(12) Patent Application Publication
(10) Pub. No.: US 2025/0110367 A1
(43) Pub. Date: Apr. 3, 2025

(54) DISPLAY DEVICE

(71) Applicant: Japan Display Inc., Tokyo (JP)

(72) Inventors: Yoshinori TANAKA, Tokyo (JP); Keita ONO, Tokyo (JP); Keiji TAGO, Tokyo (JP)

(21) Appl. No.: 18/898,013

(22) Filed: Sep. 26, 2024

(30) Foreign Application Priority Data
Sep. 29, 2023 (JP) 2023-170052

(51) Int. Cl. G02F 1/1335; G02F 1/1333; G02F 1/1334; G02F 1/13357

(52) U.S. Cl. CPC G02F 1/133553; G02F 1/133331; G02F 1/13347; G02F 1/133615

(57) ABSTRACT

According to one embodiment, a display device includes a display panel including a first end portion and a second end portion located on a side opposite to the first end portion, a first light source emitting light to the first end portion, and a first reflective member. The display panel includes an array substrate, a counter-substrate opposed to the array substrate, and a liquid crystal layer provided between the array substrate and the counter-substrate. The array substrate has a first end face which is located in the first end portion and on which the first reflective member is provided.

### CROSS-REFERENCE TO RELATED APPLICATIONS

This application is based upon and claims the benefit of priority from Japanese Patent Application No. 2023-170052, filed Sep. 29, 2023, the entire contents of which are incorporated herein by reference.

### FIELD

Embodiments described herein relate generally to a display device.

### BACKGROUND

In recent years, a display device comprising a display panel including a polymer dispersed liquid crystal layer (PDLC), a light source unit, and the like has been proposed. The polymer dispersed liquid crystal layer can switch a transmitted state in which light is transmitted and scattering state in which light is scattered according to the application of a voltage.

### BRIEF DESCRIPTION OF THE DRAWINGS

FIG. 1 is a plan view showing a configuration example of a display device.

FIG. 2 is a cross-sectional view showing a configuration example of a display panel shown in FIG. 1.

FIG. 3 is an exploded perspective view showing main portions of a display device of a first embodiment.

FIG. 4 is a cross-sectional view schematically showing a configuration example of the display device shown in FIG. 3.

FIG. 5 is a chart showing a simulation result.

FIG. 6 is a schematic cross-sectional view showing a display device of a second embodiment.

FIG. 7 is a schematic cross-sectional view showing a display device of a third embodiment.

FIG. 8 is a schematic cross-sectional view showing a display device of a fourth embodiment.

### DETAILED DESCRIPTION

In general, according to one embodiment, a display device includes a display panel including a first end portion and a second end portion located on a side opposite to the first end portion, a first light source emitting light to the first end portion, and a first reflective member. The display panel includes an array substrate, a counter-substrate opposed to the array substrate, and a liquid crystal layer provided between the array substrate and the counter-substrate. The array substrate has a first end face which is located in the first end portion and on which the first reflective member is provided.

According to this configuration, a display device capable of improving the display quality can be provided.

The embodiments will be described hereinafter with reference to the accompanying drawings. Note that the disclosure is presented for the sake of exemplification, and any modification and variation conceived within the scope and spirit of the invention by a person having ordinary skill in the art are naturally encompassed in the scope of invention of the present application.

In addition, in some cases, in order to make the description clearer, the widths, thicknesses, shapes, etc., of the respective parts are schematically illustrated in the drawings, compared to the actual modes. However, the schematic illustration is merely an example, and adds no restrictions to the interpretation of the invention. In addition, in the specification and drawings, structural elements which function in the same or a similar manner to those described in connection with preceding drawings are denoted by like reference numbers, detailed description thereof being omitted unless necessary.

In each of the embodiments, a first direction X, a second direction Y, and a third direction Z are defined as shown in each of the drawings. The first direction X, the second direction Y, and the third direction Z are orthogonal to each other, but may cross each other at an angle other than 90 degrees. Viewing an X-Y plane defined by the first direction X and the second direction Y is hereinafter referred to as plan view.

As an example of display devices, the embodiment discloses a liquid crystal display device (transparent display device) in which polymer dispersed liquid crystals are adopted and which has high light translucency. However, the configuration disclosed in the present embodiment can be applied to other types of display devices.

### FIRST EMBODIMENT

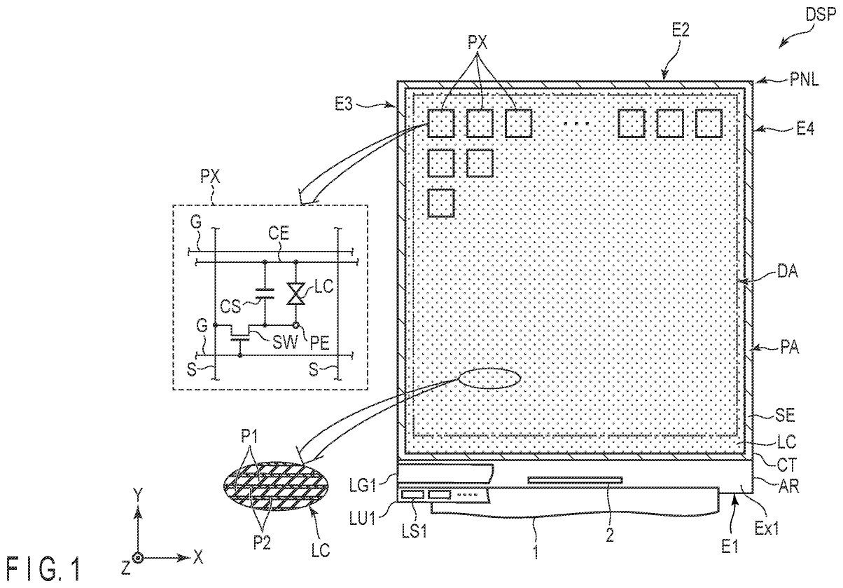

FIG. 1 is a plan view showing a configuration example of a display device DSP. The display device DSP comprises a display panel PNL, a plurality of light sources LS1 (first light sources), a light guide LG1, a wiring board 1, and IC chip 2. The plurality of light sources LS1 constitute a light source unit LU1. In FIG. 1, a part of each of the light source unit LU1 and the light guide LG1 is cut out.

The display panel PNL includes an array substrate AR, a counter-substrate CT opposed to the array substrate AR, a liquid crystal layer LC, and a seal SE. The array substrate AR and the counter-substrate CT are formed in flat plate shapes substantially parallel to the X-Y plane.

In this case, being substantially parallel means being parallel in a design concept and indicates including variation in angle caused by a manufacturing process due to the difficulty of implementing an ideal parallel state in the manufacturing.

The array substrate AR and the counter-substrate CT overlap in plan view. The array substrate AR and the counter-substrate CT are bonded to each other by the seal SE. The liquid crystal layer LC is arranged between the array substrate AR and the counter-substrate CT and is sealed by the seal SE. In FIG. 1, the liquid crystal layer LC is represented by dots and the seal SE is represented by hatch lines. The liquid crystal layer LC contains a polymer dispersed liquid crystal layer.

As shown in FIG. 1 in the enlarged manner, the liquid crystal layer LC contains a polymer P1 and liquid crystal molecules P2. For example, the polymer P1 is liquid crystal polymer. The polymers P1 are formed in a stripe streaky extending along the first direction X and are arranged in the second direction Y.

The liquid crystal molecules P2 are dispersed in gaps between the polymers P1 and are aligned such that the major axes of the liquid crystal molecules P2 are along the first direction X. Each of the polymers P1 and the liquid crystal molecules P2 has optical anisotropy or refractive anisotropy. The response performance of the polymer P1 to the electric field is lower than the response performance of the liquid crystal molecules P2 to the electric field.

For example, the orientation of alignment of the polymers P1 is hardly varied irrespective of the presence or absence of the electric field. In contrast, the orientation of alignment of the liquid crystal molecules P2 is varied in accordance with the electric field in a state in which a voltage higher than or equal to the threshold value is applied to the liquid crystal layer LC.

For example, in a state in which the voltage is not applied to the liquid crystal layer LC, optical axes of the polymers P1 and the liquid crystal molecules P2 are substantially parallel to each other and the light that has entered the liquid crystal layer LC is not substantially scattered in the liquid crystal layer LC and transmitted (transparent state).

In a state in which the voltage is applied to the liquid crystal layer LC, the optical axes of the polymers P1 and the liquid crystal molecules P2 intersect each other and the light that has entered the liquid crystal layer LC is scattered in the liquid crystal layer LC (scattered state). In other words, the liquid crystal layer LC can switch the transparent state and the scattered state in accordance with the applied voltage.

The width of the array substrate AR in the second direction Y is greater than the width of the counter-substrate CT in the second direction Y. By this configuration, the array substrate AR includes an extending portion Ex1, which does not overlap with the counter-substrate CT.

The display panel PNL includes a display area DA, which displays an image, and a surrounding area PA around the display area DA. Both the display area DA and the surrounding area SA are formed on a portion in which the array substrate AR overlaps with the counter-substrate CT. The seal SE is located in the surrounding area PA. The display area DA includes pixels PX arranged in a matrix in the first direction X and the second direction Y.

As shown in the enlarged manner in FIG. 1, a plurality of scanning lines G and a plurality of signal lines S are provided in the display area DA. The plurality of scanning lines G extend in the first direction X and are arranged in the second direction Y. The plurality of signal lines S extend in the second direction Y and are arranged in the first direction X.

Each pixel PX comprises a switching element SW, a pixel electrode PE, a common electrode CE, the liquid crystal layer LC, and the like. The switching element SW is constituted by, for example, a thin-film transistor (TFT) and is electrically connected to the scanning line G and the signal line S.

The scanning line G is electrically connected to the switching element SW in each of the pixels PX arranged in the first direction X. The signal line S is electrically connected to the switching element SW in each of the pixels PX arranged in the second direction Y.

The pixel electrode PE is electrically connected to the switching element SW. The common electrode CE is provided commonly to a plurality of pixel electrodes PE. The liquid crystal layer LC (particularly, liquid crystal molecules P2) is driven by an electric field produced between the pixel electrode PE and the common electrode CE. A capacitance CS is formed, for example, between the common electrode CE and an electrode having the same potential thereof and between the pixel electrode PE and an electrode having the same potential thereof.

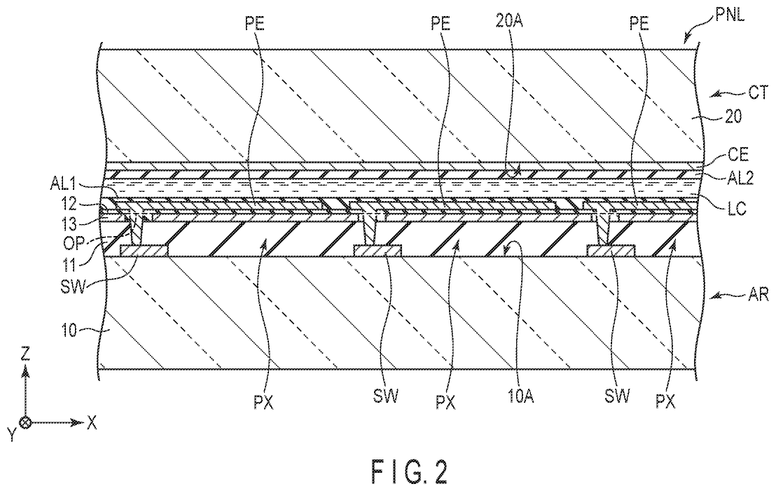

The scanning lines G, the signal lines S, the switching element SW, and the pixel electrode PE are provided on the array substrate AR, and the common electrode CE is provided on the counter-substrate CT. This configuration will be described with reference to FIG. 2. On the array substrate AR, the scanning line G and the signal line S are electrically connected to the wiring board 1 or the IC chip 2.

The plurality of light sources LS1 and the light guide LG are arranged along the extending portion Ex1. The plurality of light sources LS1 are arranged at intervals in the first direction X. The light source LS1 emits light to the light guide LG1. For example, lens such as prismatic lenses can be used as the light guide LG1.

For example, the plurality of light sources LS1 include a light emitting element which emits red light, a light emitting element which emits green light, and a light emitting element which emits blue light. These light emitting elements may be arranged in the first direction X or may be stacked in the third direction Z. For the light emitting elements, light emitting diodes (LEDs) can be used.

The wiring board 1 is, for example, a flexible printed circuit which can be bent. The IC chip 2 incorporates, for example, a display driver which outputs a signal necessary for image display, and the like. The IC chip 2 may be mounted on the wiring board 1.

In the example shown in FIG. 1, the display device DSP comprises a single wiring board 1, but may comprise a plurality of wiring boards. The display device DSP comprises a single IC chip 2, but may comprise a plurality of IC chips.

The display panel PNL comprises a first end portion E1, a second end portion E2, a third end portion E3, and a fourth end portion E4. Here, the end portion means an end and the area in the vicinity of the end. The first end portion E1 includes the extending portion Ex1.

The first end portion E1 and the second end portion E2 extend in the first direction X and are arranged in the second direction Y. The third end portion E3 and the fourth end portion E4 extend in the second direction Y and are arranged in the first direction X.

In the display panel PNL, a side on which the plurality of light sources LS1 are located in the second direction Y may be referred to as an incident side, and a side that is opposite to the incident side may be referred to as an opposite side of the incident side. The first end portion E1 is located on the incidence side, and the second end portion E2 is located on the side opposite to the incident side.

FIG. 2 is a cross-sectional view showing the configuration example of the display panel PNL shown in FIG. 1. The array substrate AR includes a transparent substrate 10, insulating films 11 and 12, a capacitive electrode 13, the switching elements SW, the pixel electrodes PE, and an alignment film AL1. The transparent substrate 10 has a main surface 10A opposed to the counter-substrate CT with the liquid crystal layer LC interposed therebetween.

The switching elements SW are provided on the main surface 10A. The insulating film 11 is provided on the main surface 10A and covers the switching elements SW. The scanning lines G and the signal lines S described with reference to FIG. 1 are provided between the transparent substrate 10 and the insulating film 11, but their illustration is omitted here. The capacitive electrode 13 is provided between the insulating films 11 and 12.

The pixel electrode PE is provided between the insulating film 12 and the alignment film AL1, in each pixel PX. From another viewpoint, the capacitive electrode 13 is provided between the transparent substrate 10 and the pixel electrodes PE.

The pixel electrodes PE are electrically connected to the switching elements SW through opening portions OP of the capacitive electrode 13. The pixel electrodes PE overlap with the capacitive electrode 13 through the insulating film 12 to form the capacitors CS of the pixels PX. The alignment film AL1 covers the pixel electrodes PE.

The counter-substrate CT includes a transparent substrate 20, the common electrode CE, and an alignment film AL2. The transparent substrate 20 has a main surface 20A opposed to the array substrate AR. The common electrode CE is provided on the main surface 20A. The alignment film AL2 covers the common electrode CE. The liquid crystal layer LC is located between the main surface 10A and the main surface 20A and is in contact with the alignment films AL1 and AL2.

In the counter-substrate CT, a light-shielding layer may be provided just above each of the switching elements SW, the scanning lines G, and the signal lines S. A transparent insulating film may be provided between the transparent substrate 20 and the common electrode CE or between the common electrode CE and the alignment film AL2.

The common electrode CE is arranged over the plurality of pixels PX and is opposed to the plurality of pixel electrodes PE. The common electrode CE has the same potential as the capacitive electrode 13. The liquid crystal layer LC is located between the pixel electrodes PE and the common electrode CE.

The transparent substrates 10 and 20 are, for example, glass substrates but may be insulating substrates such as plastic substrates. The insulating film 11 includes, for example, a transparent inorganic insulating film of silicon oxide, silicon nitride, silicon oxynitride or the like, and a transparent organic insulating film of acrylic resin or the like. The insulating film 12 is, for example, a transparent inorganic insulating film of silicon nitride or the like.

The capacitive electrode 13, the pixel electrodes PE, and the common electrode CE are, for example, transparent electrodes formed of a transparent conductive material such as indium tin oxide (ITO) or indium zinc oxide (IZO).

The alignment films AL1 and AL2 are horizontal alignment films having an alignment restriction force substantially parallel to the X-Y plane. For example, the alignment films AL1 and AL2 are subjected to alignment treatment in the first direction X. The alignment treatment may be a rubbing treatment or an optical alignment treatment.

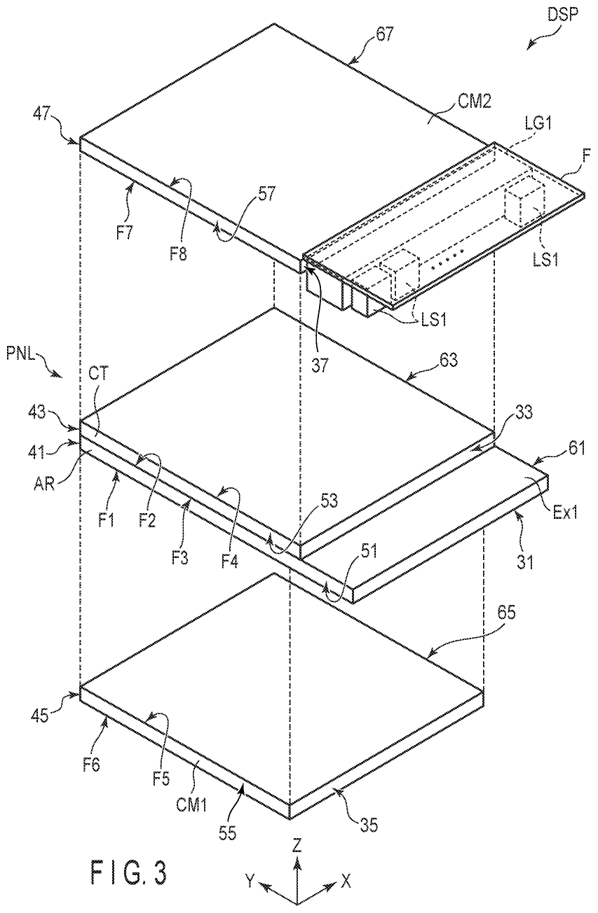

FIG. 3 is an exploded perspective view showing main portions of the display device DSP of the present embodiment. In FIG. 3, the wiring board 1, the IC chip 2, and the like are omitted.

The array substrate AR bas a main surface F1, a main surface F2 on a side opposite to the main surface F1, and end faces 31, 41, 51, and 61 connecting the main surface F1 with the main surface F2. In the present embodiment, the end face 31 corresponds to a first end face. The main surface F1 corresponds to the surface opposite to the main surface 10A of the transparent substrate 10 (shown in FIG. 2).

The end faces 31 and 41 extend in the first direction X and are arranged in the second direction Y, and the end faces 51 and 61 extend in the second direction Y and are arranged in the first direction X.

The end faces 31 and 41 are substantially parallel to the X-Z plane defined by the first direction X and the third direction Z. The end faces 51 and 61 are substantially parallel to the Y-Z plane defined by the second direction Y and the third direction Z.

The counter-substrate CT has a main surface F3 opposed to the main surface F2, a main surface F4 located on a side opposite to the main surface F3, and end faces 33, 43, 53, and 63 connecting the main surface F3 with the main surface F4. The main surface F4 corresponds to the surface opposite to a main surface 20A of the transparent substrate 20 (shown in FIG. 2).

The end faces 33 and 43 extend in the first direction X and are arranged in the second direction Y, and the end faces 53 and 63 extend in the second direction Y and are arranged in the first direction X. The end faces 33 and 43 are substantially parallel to the X-Z plane. The end faces 53 and 63 are substantially parallel to the Y-Z plane.

The display panel PNL further includes cover members CM1 and CM2. In the present embodiment, the cover member CM1 corresponds to a first cover member, and the cover member CM2 corresponds to a second cover member.

The cover member CM1, the array substrate AR, the counter-substrate CT, and the cover member CM2 are stacked in the third direction Z in this order. In the present embodiment, the third direction Z corresponds to the stack direction.

In the example shown in FIG. 3, the size of the cover member CM2 is larger than the size of the cover member CM1 in plan view. The size of the cover member CM2 may be larger or smaller than or equal to the size of the cover member CM1 in plan view.

In the example shown in FIG. 3, the cover members CM1 and CM2 do not overlap with the extending portion Ex1 in the third direction Z. The cover members CM1 and CM2 are, for example, transparent glass substrates, but may also be transparent insulating substrates such as plastic substrates.

The cover member CM1 is opposed to the array substrate AR. The cover member CM1 has a main surface F5 opposed to the main surface F1, a main surface F6 located on a side opposite to the main surface F5, and end faces 35, 45, 55, and 65 connecting the main surface F5 with the main surface F6. In the present embodiment, the end face 35 corresponds to a second end face.

The main surfaces F5 and F6 are substantially parallel to the X-Y plane. The end faces 35 and 45 extend in the first direction X and are arranged in the second direction Y, and the end faces 55 and 65 extend in the second direction Y and are arranged in the first direction X. The end faces 35 and 45 are substantially parallel to the X-Z plane. The end faces 55 and 65 are substantially parallel to the Y-Z plane.

The cover member CM2 is opposed to the counter-substrate CT. The second cover member CM2 includes a main surface F7 opposed to the main surface F4, a main surface F8 located on the side opposite to the main surface F7, and end faces 37, 47, 57, and 67 connecting the main surface F7 with the main surface F8. The main surfaces F7 and F8 are substantially parallel to the X-Y plane.

The end faces 37 and 47 extend in the first direction X and are arranged in the second direction Y, and the end faces 57 and 67 extend in the second direction Y and are arranged in the first direction X. The end faces 37 and 47 are substantially parallel to the X-Z plane. The end faces 57 and 67 are substantially parallel to the Y-Z plane.

In the display panel PNL, the end faces 31, 33, 35, and 37 are located on the first end portion E1 side, the end faces 41, 43, 45, and 47 are located on the second end portion E2 side, the end faces 51, 53, 55, and 57 are located on the third end portion E3 side, and the end faces 61, 63, 65, and 67 are located on the fourth end portion E4 side.

The plurality of light sources LS1 emit light to the first end portion E1 via the light guide LG1. More specifically, the plurality of light sources LS1 emit light to the end faces 33 and 37.

As shown in FIG. 3, the display device DSP further comprises a wiring board F. The plurality of light sources LS1 are mounted on the wiring board F. The wiring board F is, for example, a printed circuit board and is more rigid than the wiring board 1 (shown in FIG. 1).

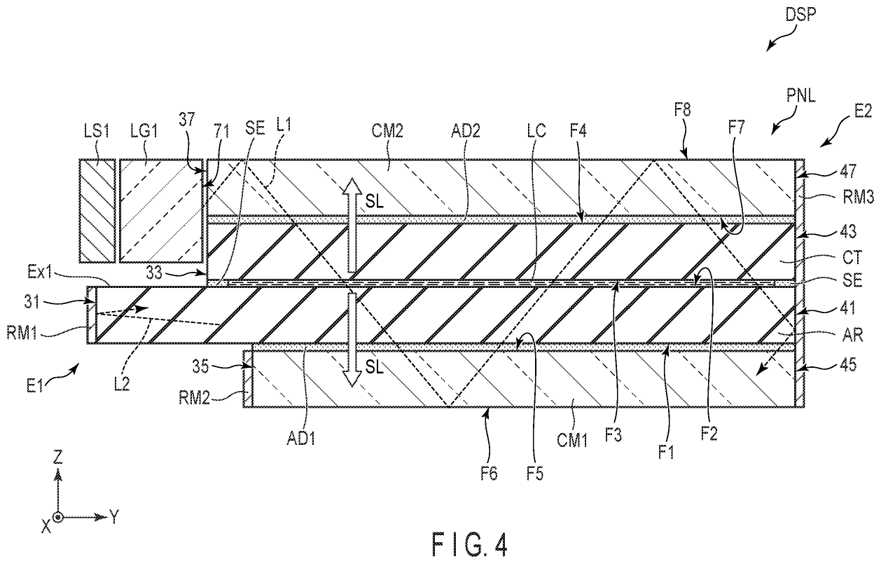

FIG. 4 is a cross-sectional view schematically showing a configuration example of the display device DSP shown in FIG. 3. In FIG. 4, the wiring board 1, the IC chip 2, and the like are omitted. Main parts alone of the display panel PNL are simply illustrated. FIG. 4 shows the display device DSP viewed from the direction opposite to the first direction X.

The display device DSP further comprises an adhesive layer AD1 and an adhesive layer AD2. The adhesive layer AD1 is located between the array substrate AR and the cover member CM1, and the adhesive layer AD2 is located between the counter-substrate CT and the cover member CM2.

More specifically, the adhesive layer AD1 bonds the main surface F1 of the array substrate AR and the main surface F5 of the cover member CM1 together, and the adhesive layer AD2 bonds the main surface F4 of the counter-substrate CT and the main surface F7 of the cover member CM2 together.

The adhesive layers AD1 and AD2 are transparent and formed of, for example, optical clear adhesive (OCA). The adhesive layers AD1 and AD2 may be formed of optical clear resin (OCR).

The refractive indexes of the transparent substrates 10 and 20 (shown in FIG. 2), the adhesive layers AD1 and AD2, and the cover members CM1 and CM2 are equivalent to each other. In this example, “equivalent” is not limited to a case where the refractive index difference is zero, but indicates a case where the refractive index difference is 0.1 or less.

The display device DSP further comprises reflective members RM1, RM2, and RM3. In the present embodiment, the reflective member RM1 corresponds to a first reflective member, the reflective member RM2 corresponds to a second reflective member, and the reflective member RM3 corresponds to a fourth reflective member.

The reflective members RM1, RM2, and RM3 reflect light propagating inside the display panel PNL. The reflective members RM1, RM2, and RM3 are formed of, for example, a metallic material having light-reflecting properties, such as silver.

The reflective members RM1, RM2, and RM3 are, for example, reflective tapes (silver tape). As another example, the reflective members RM1, RM2, and RM3 may be reflective films formed by vapor deposition and the like.

The reflective members RM1 and RM2 are provided on the first end portion E1, and the reflective member RM3 is provide on the second end portion E2. More specifically, the reflective member RM1 is provided on the end face 31, the reflective member RM2 is provided on the end face 35, and the reflective member RM3 is provided over the end faces 45 to 47. From another viewpoint, the reflective members RM1 and RM2 are located on the incidence side, and the reflective member RM3 is located on the side opposite to the incident side.

In the example shown in FIG. 4, the end face 37 is located directly above the end face 33, and the end face 35 is not located directly below the end face 33. The end faces 41, 43, 45, and 47 are aligned with each other in the third direction Z. That is, the end faces 41, 43, 45, and 47 are located on the same plane. The extending portion Ex1 is formed on a portion protruding relative to the end face 33 of the array substrate AR.

In the second direction Y, the light source LS1 is opposed to each of the end faces 33 and 37 with the light guide LG1 interposed therebetween. From another viewpoint, the light guide LG1 is located between the cover member CM2 and the light source LS1 and between the counter-substrate CT and the light source LS1 in the second direction Y.

The end face 71 of the light guide LG1 is opposed to each of the end faces 33 and 37. The light source LS1 emits light to the end faces 33 and 37. The light emitted from the light source LS1 travels along a direction of an arrow indicative of the second direction Y.

The propagation of light L1 in the display device DSP will be described.

The light L1 emitted from the light source LS1 is moderately diffused on the light guide LG1, enters the counter-substrate CT from the end face 33, and enters the cover member CM2 from the end face 37.

This light L1 travels toward the side opposite to the incident side while being repeatedly subjected to total reflection between the main surface F6 and the main surface F8. The light L1 reaching the second end portion E2 is reflected by the reflective member RM3 and travels toward the incidence side while being repeatedly subjected to total reflection between the main surface F6 and the main surface F8. FIG. 4 shows propagation of light which enters the cover member CM2 from the end face 37 as an example.

The display device DSP comprises the reflective members RM1 and RM2 provided on the incidence side. Therefore, light that has been reflected on the reflective member RM3 and reaches the end faces 31 and 35 is reflected by the reflective members RM1 and RM2 and then travels toward the side opposite to the incident side again. FIG. 4 shows propagation of light 12 reflected by the reflective member RM1 as an example.

Light can be prevented from being leaked from the end faces 31, 35, 41, 43, 45, and 47 by providing the reflective members RM1, RM2, and RM3 in this manner. That is, light can tends to stay between the first end portion E1 and the second end portion E2. Thus, the light emitted from the light source LS1 can be reused and thus light utilization efficiency can be increased in the display device DSP.

Light is hardly scattered by the liquid crystal layer LC in the vicinity of the pixels PX in transparent state. Thus, light is not substantially leaked to the outside of the cover members CM1 and CM2. On the other hand, light is scattered on the liquid crystal layer LC in the vicinity of the pixels PX in scattered state.

This scattered light SL is emitted from the cover members CM1 and CM2 and is visually recognized as a display image by a user. The gradation expression of the degree of scattering (luminance) can be realized by defining the voltage to be applied to the pixel electrodes PE in stages in a predetermined range.

It should be noted that, in the vicinity of a pixel in a transparent state, the external light that enters the cover member CM1 or CM2 is not substantially scattered and passes through the liquid crystal layer LC. Thus, when the display device DSP is viewed from the first cover member CM1 side, the background on the second cover member CM2 side can be visually recognized. When the display device DSP is viewed from the second cover member CM2 side, the background on the first cover member CM1 side can be visually recognized.

For example, as a system for displaying an image by the display device DSP, the following field sequential system could be used. The field sequential system repeats a first subframe in which a red image is displayed by lighting up the red light emitting elements of the light sources LS1, a second subframe in which a green image is displayed by lighting up the green light emitting elements and a third subframe in which a blue image is displayed by lighting up the blue light emitting elements.

Next, simulation results will be described.

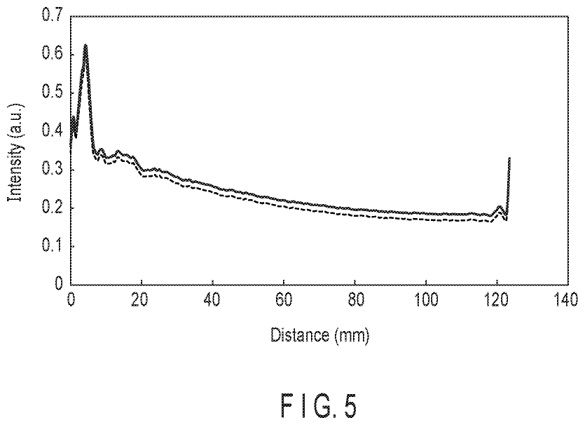

FIG. 5 is a chart showing a simulation result. In the following simulations, the light intensity in the liquid crystal layer LC is simulated with assuming a case where the light is emitted from the plurality of light sources LS1. The light intensity may be hereinafter referred to as intensity.

In addition, an image display and the like in the display device DSP are achieved by scattering of light in the liquid crystal layer LC, and thus the luminance of the display device corresponds to the light intensity. FIG. 5 shows the simulation result in each of the display device DSP and a display device of a comparative example.

The conditions in the simulation are as follows.

The thickness of the array substrate AR is 0.7 mm, the thicknesses of the counter-substrate CT is 0.7 mm, the thicknesses of each of the cover members CM1 and CM2 is 0.7 mm, and the thicknesses of each of the adhesive layers AD1 and AD2 is 0.125 mm. The length of the array substrate AR in the second direction Y is 128.75 mm, the length of each of the counter-substrate CT and the cover member CM2 in the second direction Y is 123.65 mm, and the length of the cover member CM1 in the second direction Y is 120 mm.

As described with reference to FIG. 4, the display device DSP comprises the reflective members RM1, RM2, and RM3. The display device of the comparative example is different from the display device DSP in not comprising the reflective members RM1 and RM2.

In FIG. 5, the horizontal axis shows a distance [mm] from the incidence side of the liquid crystal layer LC, and the vertical axis shows the intensity [a.u.]. FIG. 5 shows the luminance of the display device DSP by a solid line and the intensity of the display device of the comparative example by a broken line.

As shown in FIG. 5, it has been confirmed that the display device DSP generally has intensities greater than the display device of the comparative example. More specifically, it has been confirmed that the intensity increases by about 5% in the display device DSP.

As described above, the present embodiment can provide the display device DSP capable of improving the display quality.

For example, for increasing the luminance, it is conceivable to increase the power input to the LEDS, which are the light source LS. However, from the view of energy saving and heat dissipation design in the display device DSP, it is more preferable to increase the luminance by efficiently utilizing light from the light source LS1 rather than increasing the power input.

The display device DSP can efficiency utilize the light emitted from the light source LS1, and thus the luminance of the display light can be increased without increasing the power input to the light source LS1. That is, display light having the same luminance as that of the comparative example can be achieved by power consumption less than the power consumption in the comparative example.

Next, another embodiment will be explained.

In the following another embodiment and modified examples, constituent elements identical to those of the first embodiment described above will be designated by the same reference numbers, and detailed descriptions therefor will be omitted or simplified in some cases.

### SECOND EMBODIMENT

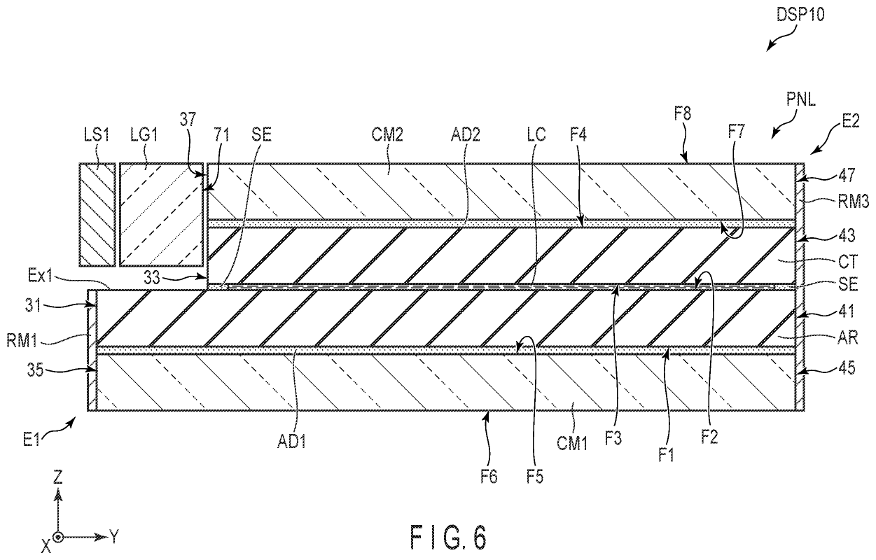

FIG. 6 is a schematic cross-sectional view of a display device DSP10 of the present embodiment. The present embodiment is different from the first embodiment in the shape of a cover member CM1. In the present embodiment, an end face 31 corresponds to a first end face, and an end face 35 corresponds to a second end face.

In the example shown in FIG. 6, the size of the cover member CM1 is substantially equivalent to that of an array substrate AR. In the relationship with a cover member CM2, the size of the cover member CM1 is larger than the size of the cover member CM2.

In the present embodiment, the end face 35 of the cover member CM1 is located directly below the end face 31 of the array substrate AR. That is, the end face 35 is aligned with the end face 31 in the third direction Z.

In the present embodiment, the reflective member RM1 is provided over the end face 31 and the end face 35. The reflective member RM1 is, for example, formed of one reflective tape.

The same advantages as those of the first embodiment can also be obtained from the configuration of the present embodiment. The end face 35 and the end face 31 are aligned with each other in the present embodiment. Thus, one reflective member RM1 can be provided over the end face 31 and the end face 35. Compared to the case where one reflective member is provided for each of the end faces 31 and 35, the present embodiment can shorten the time to attach a reflective member and thus suppress the manufacturing cost of the display device DSP10.

### THIRD EMBODIMENT

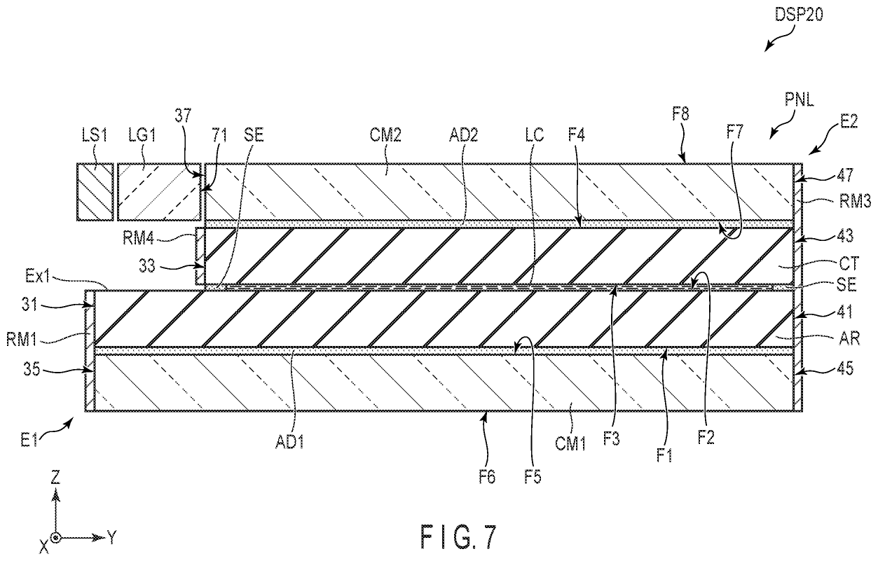

FIG. 7 is a schematic cross-sectional view of a display device DSP20 of the present embodiment. The present embodiment is different from the second embodiment in the shape of a light source LS1 and the shape of a light guide LG1. In the present embodiment, an end face 31 corresponds to a first end face, an end face 33 corresponds to a fourth end face, an end face 35 corresponds to a second end face, and an end face 37 corresponds to a third end face.

The light source LS1 is opposed to the end face 37 with the light quide LG1 interposed therebetween but is not opposed to the end face 33 in the second direction Y. An end face 71 of the light guide LG1 is opposed to the end face 37 but is not opposed to the end face 33. The light source LS1 emits light to the end face 37.

The display device DSP20 further comprises a reflective member RM4 (third reflective member). The reflective member RM4 is provided on the end face 33. The reflective member RM4 is formed of, for example, the same material of that of the above-described reflective member RM1.

The same advantages as those of each of the embodiments described above can also be obtained from the configuration of the present embodiment. In the present embodiment, the reflective member RM4 is provided on the end face 33. This configuration allows the reflective member RM4 to reflect light that has been reflected on the reflective member RM3 and reaches the incidence side.

In other words, light can be prevented from being leaked from the end face 33, and thus light utilization efficiency in the display device DSP20 can be increased. The light source LS1 and the light guide LG1 in the present embodiment can be adopted in the display device DSP of the first embodiment.

### FOURTH EMBODIMENT

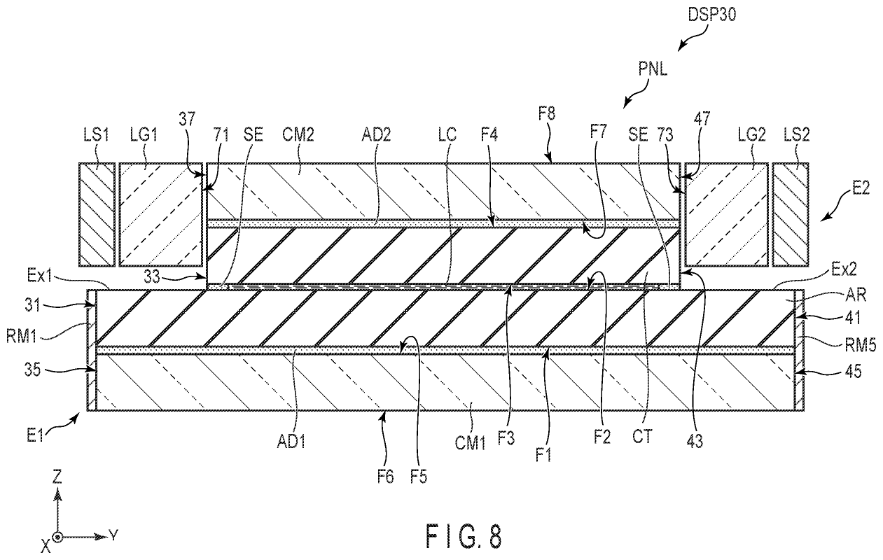

FIG. 8 is a schematic cross-sectional view of a display device DSP30 of the present embodiment. In the present embodiment, an end face 31 corresponds to a first end face, an end face 33 corresponds to a fourth end face, an end face 35 corresponds to a second end face, an end face 37 corresponds to a third end face, an end face 41 corresponds to a fifth end face, and an end face 45 corresponds to a sixth surface.

In the example shown in FIG. 8, an array substrate AR further includes an extending portion EX2 not overlapping with a counter-substrate CT. The extending portion Ex2 is located on a side opposite to an extending portion Ex1. The extending portion Ex2 is included in a second end portion 62.

The display device DSP30 further comprises a plurality of light sources LS2 (second light source) and a light quide LG2. The plurality of light sources LS2 and the light guide LG2 are provided along the extending portion Ex2. The plurality of light sources LS2 are arranged at intervals in the first direction X. The light source LS2 emits light to the light guide LG2. For example, a lens such as a prism lens can be used as the second light quide LG2, similarly to the light quide LG1.

The light source LS2 is opposed to end faces 43 and 47 with the light quide LG2 interposed therebetween in the second direction Y. An end face 73 of the light guide LG2 is opposed to each of the end faces 43 and 47. The plurality of light sources LS2 emit light to the second end portion E2 via the light guide LG2. More specifically, the plurality of light sources LS2 emit light to the end faces 43 and 47.

The display device DSP30 further comprises a reflective member RM5 (fifth reflective member). The end face 45 of the cover member CM1 is located directly below the end face 41 of the array substrate AR. That is, the end face 45 is aligned with the end face 41 in the third direction Z. The end face 35 of the cover member CM1 is located directly below the end face 31 of the array substrate AR. That is, the end face 35 is aligned with the end face 31 in the third direction Z.

In the present embodiment, the reflective member RM1 is provided over the end face 31 and the end face 35, and the reflective member RM5 is provided over the end face 41 and the end face 45. Each of the reflective members RM1 and RM5 is formed of, for example, one reflective tape. The reflective member RM5 is formed of, for example, the same material of that of the above-described reflective member RM1.

The same advantages as those of each of the embodiments described above can also be obtained from the configuration of the present embodiment. In the present embodiment, the display device DSP30 comprises a plurality of the light sources LS1 and the plurality of light sources LS2.

This configuration allows the luminance of the display device DSP30 to be greater than the luminance of the display device of each of the embodiments. By comprising the reflective members RM1 and RM5, the display device DSP30 can prevent light 30 from being leaked from the end faces 31, 35, 41, and 45, and thus increase the light utilization efficiency.

The shapes of the light sources LS1 and the light guide LG1 in the third embodiment can be adopted in the light sources LS1 and LS2 and the light guides LG1 and LG2 in the present embodiment. In that case, a reflective member can be further provided on the end faces 33 and 43 of the counter-substrate CT.

The present embodiment discloses a case where the end face 35 is aligned with the end face 31, the end face 45 is aligned with the end face 41. However, the end face 35 may not be aligned with the end face 31, and the end face 45 may not be aligned with the end face 41.

Each of the above-described embodiments discloses examples in which a reflective member is provided on the first end portion E1 and the second end portion E2. However, a reflective member may be provided on the third end portion E3 and the second end portion E2. More specifically, a reflective member may be provided on each of the end faces 51 and 61 of the array substrate AR, the end faces 53 and 63 of the counter-substrate CT, the end faces 55 and 65 of the cover member CM1, and the end faces 57 and 67 of the cover member CM2. Thus, light can be further prevented from being leaked from the display panel PNL and thus the light utilization efficiency can be increased further.

All of the display devices that can be implemented by a person of ordinary skill in the art through arbitrary design changes to the display device described above as the embodiment of the present invention come within the scope of the present invention as long as they are in keeping with the spirit of the present invention.

Various types of the modified examples are easily conceivable within the category of the ideas of the present invention by a person of ordinary skill in the art and the modified examples are also considered to fall within the scope of the present invention. For example, even if a person of ordinary skill in the art arbitrarily modifies the above embodiments by adding or deleting a structural element or changing the design of a structural element, or adding or omitting a step or changing the condition of a step, all of the modifications fall within the scope of the present invention as long as they are in keeping with the spirit of the invention.

In addition, the other advantages of the aspects described in the embodiments, which are obvious from the descriptions of the present specification or which can be arbitrarily conceived by a person of ordinary skill in the art, are considered to be achievable by the present invention as a matter of course.

What is claimed is:

1. A display device, comprising:
a display panel including a first end portion and a second end portion located on a side opposite to the first end portion;
a first light source emitting light to the first end portion; and
a first reflective member, wherein
the display panel includes an array substrate, a counter-substrate opposed to the array substrate, and a liquid crystal layer provided between the array substrate and the counter-substrate, and
the array substrate has a first end face which is located in the first end portion and on which the first reflective member is provided.

2. The display device of claim 1, further comprising:
a second reflective member, wherein
the display panel further includes a first cover member opposed to the array substrate, and
the first cover member has a second end face which is located in the first end portion and on which the second reflective member is provided.

3. The display device of claim 1, wherein
the display panel further includes a first cover member opposed to the array substrate, and
the first cover member has a second end face which is located in the first end portion and is aligned with the first end face in a stack direction.

4. The display device of claim 3, wherein
the first reflective member is located on the first end face and the second end face.

5. The display device of claim 2, wherein
the display panel further includes a second cover member opposed to the counter-substrate,
the second cover member has a third end face located in the first end portion, and
the first light source is opposed to the third end face.

6. The display device of claim 5, further comprising:
a third reflective member, wherein
the counter-substrate has a fourth end face which is located in the first end portion and on which the third reflective member is provided.

7. The display device of claim 1, further comprising:
a fourth reflective member provided on the second end portion.

8. The display device of claim 1, further comprising:
a second light source emitting light to the second end portion; and
a fifth reflective member, wherein
the array substrate has a fifth end face which is located in the second end portion and on which the fifth reflective member is provided.

9. The display device of claim 8, wherein
the display panel further includes a first cover member opposed to the array substrate, and
the first cover member has a second end face which is located in the first end portion and is aligned with the first end face in a stack direction and has a sixth end face which is located in the second end portion and is aligned with the fifth end face.

10. The display device of claim 9, wherein
the first reflective member is located on the first end face and the second end face, and
the fifth reflective member is located on the fifth end face and the sixth end face.

11. The display device of claim 8, wherein
the display panel further includes a second cover member opposed to the counter-substrate.

12. The display device of claim 1, wherein
the liquid crystal layer contains polymer dispersed liquid crystals.

13. The display device of claim 4, wherein
the first reflective member is formed of a reflective tape provided over the first end face and the second end face.

14. The display device of claim 10, wherein
the first reflective member is formed of a reflective tape provided over the first end face and the second end face, and
the fifth reflective member is formed of a reflective tape provided over the fifth end face and the sixth end face.

15. The display device of claim 6, wherein
the array substrate further includes an extending portion protruding relative to the fourth end face, and
the first light source is provided along the extending portion.

16. The display device of claim 4, further comprising:
a fourth reflective member provided on the second end portion.

17. The display device of claim 6, further comprising:
a fourth reflective member provided on the second end portion.

18. The display device of claim 10, wherein
the display panel further includes a second cover member opposed to the counter-substrate.
